(19) United States
(12) Patent Application Publication
(10) Pub. No.: US 2003/0012345 A1
(43) Pub. Date: Jan. 16, 2003

(54) Method and apparatus for improved calling access

(76) Inventors: Derek J. Marsh, Bangkok (TH); Daniel Morgan Daly, Saratoga, CA (US); John Sheill, San Jose, CA (US)

Correspondence Address: QUINE INTELLECTUAL PROPERTY LAW GROUP, P.C., P O BOX 458, ALAMEDA, CA, 94501, US

(21) Appl. No.: 09/800,262

(22) Filed: Mar. 5, 2001

Related U.S. Application Data
(60) Provisional application No. 60/187,140, filed on Mar. 6, 2000.

(51) Int. Cl. H04M 1/64

(52) U.S. Cl. 379/67.1; 379/88.22

(57) ABSTRACT

A method and apparatus for providing a prepaid calling account with an associated message mailbox. In various embodiments, the calling account may allow prepaid telephone access using the calling account, access to a message mailbox associated with the calling account, and retrieval of messages, paid for out of the same calling account. In further embodiments a prepaid calling account has at least two account access identifications, one identification allowing a remote party to add funds to the account. In further embodiments, one identification allowing a remote party to add finds to the account and another access identification allowing a cash back option so that funds may be transferred. In further embodiments, a method and/or apparatus allows a user of a message mailbox to originate a call with, in specific embodiments, a call originating out of the message mailbox carrying a caller-id number indicating the message mailbox. In further specific embodiments, a message in the mailbox may have associated with it funds placed on deposit that are used to pay for access to the message and for returning a call associated with the message. In further embodiments, the invention allows a message to be left at a local number in one calling area and to be retrieved from a local number in a different calling area.

This application claims benefit of priority from provisional patent application 60/187,140 filed Mar. 6, 2000, which is incorporated herein by reference.

### FIELD OF THE INVENTION

The present invention relates to providing communication services. In further embodiment, the present invention relates to providing fund exchange transactions, including transactions to pay for communication services.

More specifically, in a first group of specific embodiments, the present invention is directed to a variety of methods and/or associated systems for providing communication access in areas without highly developed telephone networks and in further embodiments for providing access to certain financial services.

More specifically, in a further group of specific embodiments, the present invention is directed to a prepaid calling account that has an associated message mailbox.

More specifically, in a further group of specific embodiments, the present invention is directed to a calling account that has associated with it at least two identifications, one identification allowing use of calling account services and a second identification allowing transfer of funds into the calling account.

More specifically, in a further group of specific embodiments, the present invention is directed to a calling account that allows the account holder to receive cash back or make other purchases with the account and that further allows transfer of funds into the calling account, possibly from a very remote location, thus providing an effective mechanism for transferring funds internationally.

More specifically, in a further group of specific embodiments, the present invention is directed to a voice mailbox that allows call origination through to a public communications network with a call return identification.

More specifically, in a further group of specific embodiments,, the present invention is directed to a public message delivery service that allows a person at a remote location from the message mailbox to leave messages in a local system without making a long-distance telephone connection.

### COPYRIGHT NOTICE

Permission is hereby granted to make copies of this application and parts thereof solely in connection with the making of facsimile copies of this patent document in accordance with applicable law; all other rights are reserved, and all other reproduction, distribution, creation of derivative works based on the contents, public display, and public performance of the application or any part thereof are prohibited by copyright laws.

### APPENDIX

This application is being filed with a paper APPENDIX totaling 9 pages, which is incorporated herein fully by reference. This appendix described various details and aspects of a specific implementation according to specific embodiments of the present invention.

### BACKGROUND OF THE INVENTION

At present a very wide range of communication services are available. These services can provide voice or facsimile mail, messaging, collect calling, prepaid calling, phonecard calling, and other services. For the most part, however, existing communication services have been designed for use in technologically developed locations with a large and extensive communication and business transaction infrastructure.

Message mailbox services, for example, are generally associated with an individual telephone line. Such services have little or no applicability to locations where a large portion of a population does not have private telephone service. Other message systems are known wherein a user can pay for a mailbox that is not associated with a private telephone line and at which messages can be left. Generally, such services expect that the user has easy access to a private telephone, facsimile machine, or computer or a coin operated public telephone device and can easily make a call into the message system to retrieve messages. Typically such message systems are fee systems wherein a user is billed on a periodic basis for the service.

Further, while private telephone lines for which consumers are periodically billed for service are common in the technologically developed world, in less technologically developed areas, many people access communication services on shared or public telephone devices. Payment for accessing these services is generally made at the time of use, either through currency, barter, or use of a prepaid telephone card.

It is not uncommon for people located in less technologically or economically developed areas to rely on telephone services to communicate with family members or others who live in more economically developed areas. In such cases, the family member in the more economically developed area may wish to provide the funds to pay for a communication. At present, there are generally two options available to transfer funds to a remote party for calling: a collect telephone call or transferring currency or credit authorization to the person in the less economically developed area. Collect telephone calls can be undesirable in many situations. First, it assumes a telephone billing system that can link back from the party receiving the call to the location and billing entity of the caller. Where the call is made from a shared private telephone or from many remote public telephones, this linkage does not exist. Transferring currency or credit authorization is also often undesirable due to the expense of wire transfers, the possibility of theft, or the possibility that the funds, once received, will not be used for the intended communication purposes.

Furthermore, transferring funds through wire services, such as banks of Western Union™ can be extremely expensive, in some cases involving fees as high as approximately 10% of the funds transferred.

While private telephone lines for which consumers are periodically billed for service are common in the technologically developed world, in less technologically developed areas, many people access communication services on shared or public telephone devices. Payment for accessing these services is generally made at the time of use, either through currency, barter, or use of a prepaid telephone card.

Co-assigned, related invention disclosures herein discuss various systems and/or methods for providing a calling account especially for those who do not have a private phone line, including providing a calling account with an associated message mailbox for receiving messages. However, one problem that may be encountered by users of such services is that calls made from the calling account are generally not identified with a caller_id number that is useful for call identification or call return. The originating number caller_id number in such systems is a central call origination system or a public or shared telephone line. In many instances, it is undesirable to return a call to a public or shared private line.

Furthermore, leaving a message for a family member or other person located very far away can be an inconvenient, difficult and expensive proposition. For the person living in the more developed area, calling through to the usual contact number may mean placing a call to a local store and home located some distance from their families residence and leaving a message with shopkeeper or other owner of a shared telephone and then waiting minutes, hours, or days before a written transcription of the message reaches its intended recipient. In areas of lower literacy, this can be a further problem. For the person living in the less developed area, placing a call that is likely to be received to an answering machine or voicemail box is expensive and where the caller does not have a private phone, the call is difficult to return without encountering the problem just stated.

Prior Patents and Publications

The following patents and/or other publications may be related to the invention or provide background information. Listing of these references here should not be taken to indicate that any formal search has been completed or that any of these references constitute prior art.

| | |
|---|---|
| U.S. Pat. No. 5,559,867 | Automated Calling System With |
| | Database Updating |
| U.S. Pat. No. 5,673,309 | Atm Phone Card System |
| U.S. Pat. No. 5,696,908 | Telephone Debit Card Dispenser And Method |
| U.S. Pat. No. 4,650,977 | Automatic Self Service Machine |
| | System And Method |
| U.S. Pat. No. 5,144,649 | Cellular Radiotelephone Credit Card |
| | Paystation Method |
| U.S. Pat. No. 5,448,043 | Foreign Remittance Transaction Terminal |
| | Apparatus And Foreign Remittance Transaction |
| | System Employing The Same |
| U.S. Pat. No. 5,455,407 | Electronic-Monetary System |
| U.S. Pat. No. 5,371,797 | Secure Electronic Funds Transfer From |
| | Telephone Or Unsecured Terminal |
| U.S. Pat. No. 5,621,787 | Prepaid Cash Card |
| U.S. Pat. No. 5,719,926, | Prepaid Long-Distance Telephone Service |
| | System With Flexible Operating Parameters |

U.S. Pat. No. 5,719,926, issued Feb. 17, 1998, entitled Prepaid long-distance telephone service system with flexible operating parameters, discusses a long-distance telephone service system with flexible, customizable control of long-distance telephone usage by customers, especially prepaid long-distance service customers. The discussed system includes global operating parameters associated each access number and a database of user accounts or card numbers and allows an owner of a card to establish an account for recharging the prepaid balance of existing accounts from locations remote to the account database.

### SUMMARY OF THE INVENTION

First Embodiment: Method And Apparatus For Prepaid Calling Account With Associated Message Mailbox

In a particular embodiment, the present invention includes a calling account with an associated message mailbox. In an embodiment, a calling account may be associated with one or more calling cards. Calling cards can have a fixed or rechargeable value and are associated with an identification number, which may be printed or written on the card or may be otherwise stored on the card.

A calling account with associated message mailbox, according to various embodiments of the invention, can provide its owner with a variety of services, all of which, in specific embodiments, may be paid for from the same prepaid calling account. One service is to allow prepaid telephone access using the calling account, in much the same way as is known from prepaid calling cards. A second service is a message mailbox that is associated with the calling account that can receive and store messages from parties knowing the mailbox number of the account. A third service is that the owner of the calling card can retrieve messages left for him or her, again prepaid from the same calling account.

Second Embodiment: Method And Apparatus For A Calling Account With A Recharging Identification

According to the present invention, a communications account is provided with a private access identification number which is necessary to use the account services and to accrue charges. A second identification number is provided that allows for adding funds to the account and possibly for accessing account balance information. In some situations, this second number may also act as a number for leaving voice messages.

In an embodiment, a calling account may be associated with one or more calling cards, having either fixed or rechargeable values and each associated with an identification number that may be printed or written on the card or may be otherwise store on the card.

According to various embodiments of the invention, a calling account can provide its owner access to a variety of services, such as, without limit: prepaid telephone access; a message mailbox retrieval of messages, or other services.

Adding Value Through a Second Identification

According to a further embodiment of the invention, a recharge identification 22a may be associated with a calling account. Id 22a allows a party to add value into a calling card account, possibly from a location far distant from the owner of the calling account.

In specific embodiments, this aspect of the invention may be understood as follows:

Person A in Location A wishes to add funds to account B in Location B.

Person A makes a communication connection (via telephone, e-mail, etc.) to an access number or electronic address. In the case of a phone call embodiment, this may be a local phone call to person A or a toll-free call.

Person A gives an identification for account B and indicates that he wants to add value to the account. This identification does not necessarily allow person A to perform other actions with the account, such as placing a call or accessing messages. A menu may allow person A to determine the amount left on the account or to perform other functions.

Person A provides a fund transfer identification, such as a credit card number, and an amount to the system.

The system transfers funds as indicated by person A and adds funds to account B.

Funds are available in account B at location B to use in accordance with the account.

Various specific embodiments of the invention may also allow person A to restrict use of the funds, such as allowing the funds to be used only to return phone calls to person A or only to listen to messages left by person A.

A Rechargeable Calling Account With A Cash Back Option

According to further embodiments of the present invention, an account is provided with a private access identification number which is necessary to use the account services, to accrue charges, or to withdraw funds from the account. A second identification number is provided that allows for adding funds to the account and possibly for accessing account balance information. A person in one location who wishes to transfer funds to the calling account may use a public communications network or some other communications mechanism and provide the recharge identification of the calling account and authorization to transfer funds.

According to further embodiments of the invention, once the funds are transferred, the owner of account B may be allowed to withdraw a portion of all of the funds for uses other than the communication account.

A Message Mailbox With Call Origination Features

According to further embodiments of the present invention, a message mailbox that is can be accessed from multiple telephone numbers allows a user of the mailbox to place calls out of the mailbox. The call return number or caller-id number associated with the mailbox is necessary to use the account services.

In a further embodiment, a speed-dial option may be associated with a message mailbox or with individual messages received into the mailbox. In a still further embodiment, a message left in a mailbox can be associated with a call return number and a prepayment value or a charge authorization. In a further embodiment, a conference call may be placed from the mailbox, using a meet-me time or feature. In a further embodiment, a meet-me scheduling ability can be allowed from the mailbox.

A Message Mailbox Allowing Remote Message Deposit

According to the present invention, an message mailbox may have a message delivered to it from a remote access point. This remote access point may have a local or toll-free number associated with it that allows a remote caller to leave a message in a message mailbox for transmission to a message mailbox at a time or in a format that will allow less expensive call carrying.

In a further embodiment, the invention provides a particularly effective method for leaving messages in a message mailbox when that mailbox is not associated with a private telephone line. This method is particularly advantageous when the caller is located a great distance from the called party and would otherwise have to place an international toll call to reach the called party.

In further embodiments, the invention can be incorporated with other advanced calling and mailbox features to provide additional advantageous as herein described.

Described herein are a number of innovative techniques and mechanisms related to telephone and/or messaging services. Many of these techniques have particular advantageous when employed in less economically or technologically advanced areas where private telephone services is not as widely available. While separate descriptions, using the teachings provided herein it will be apparent that all of these techniques, or various combinations of these techniques, may be advantageously used together to provide effective telephone services.

From the teachings provided herein, it will be seen that the present invention according to specific embodiments provides a method or apparatus that will allow a user to receive and retrieve messages from an electronic mailbox where the user does not have easy access to a private telephone or coin-operated telephone or where it is impractical for the recipient to receive and pay a periodic bill.

From the teachings provided herein, it will be seen that the present invention according to specific embodiments also provides a method or apparatus that will allow one party to conveniently, inexpensively, and reliably provide funding for another person to gain access to communication services.

From the teachings provided herein, it will be seen that the present invention according to specific embodiments also provides a method or apparatus that will allow one party to conveniently, inexpensively, and reliably transfer funds to another person, using easily available telephone communication.

From the teachings provided herein, it will be seen that the present invention according to specific embodiments also provides a method or apparatus that will allow a person who does not have access to a private phone line to place phone calls with a call return feature that will allow a returned call or message to get back to the caller.

From the teachings provided herein, it will be seen that the present invention according to specific embodiments also provides a method or apparatus that will allow one party to conveniently, inexpensively, and reliably leave a message for a message mailbox in another country without needing to make a long distance connection.

While various aspects of the present invention are described herein as independent methods, it will be understood from the teachings herein that in specific embodiments different aspects of the present invention can be advantageously used with a number of other message mailbox or calling account features, such as various novel elements described herein.

The invention and various specific aspects and embodiments will be better understood with reference to the following drawings and detailed descriptions. In different figures, similarly numbered items are intended to represent similar functions within the scope of the teachings provided herein. In some of the drawings and detailed descriptions below, the present invention is described in terms of the important independent embodiment of providing calling services in environments when regular private residential telephone service is not widely available or utilized. This should not be taken to limit the invention, which, using the teachings provided herein, can be applied to other situations. For purposes of clarity, this discussion refers to devices, methods, and concepts in terms of specific examples. However, the invention and aspects thereof may have applications to a variety of types of devices and systems. It is therefore intended that the invention not be limited except as provided by the attached claims and equivalents.

Furthermore, it is well known in the art that logic and/or digital and/or communications systems and/or methods can include a wide variety of different components and different functions in a modular fashion. The following will be apparent to those of skill in the art from the teachings provided herein: different embodiments of the present invention can include different combinations of elements and/or functions; different embodiments of the present invention can include actions or steps performed in a different order than described in any specific example herein; and different embodiments of the present invention can include groupings of parts or components into larger parts or components different than described in any specific example herein.

For purposes of clarity, the invention is described in terms of systems that include many different innovative components and innovative combinations of innovative components and known components. No inference should be taken to limit the invention to combinations containing all of the innovative components listed in any illustrative embodiment in this specification.

The functional logical aspects of the invention, as will be understood from the teachings herein, may be implemented or accomplished using any appropriate (either as presently known or developed in the future) implementation environment or programming language, such as C++, Cobol, Pascal, Java, Java-script, etc.

A further understanding of the invention can be had from the detailed discussion of specific embodiments below. For purposes of clarity, this discussion refers to devices, methods, and concepts in terms of specific examples. However, the method of the present invention may operate with a wide variety of types of communication devices and digital components. It is therefore intended that the invention not be limited except as provided in the attached claims.

All publications, patents, and patent applications cited herein are hereby incorporated by reference in their entirety for all purposes. The invention will be better understood with reference to the following drawings and detailed description.

### BRIEF DESCRIPTION OF THE DRAWINGS

FIG. 1 is a block diagram illustrating calling account with associated message mailbox usage according to specific embodiment of the present invention.

FIG. 2A is a more detailed block diagram of a telephone and messaging system according to an embodiment of the invention.

FIG. 2B is an alternative more detailed block diagram of a telephone and messaging system according to an embodiment of the invention.

FIG. 3 is a detailed block diagram of a telephone and messaging system according to an alternative embodiment of the invention.

FIG. 4 is an illustration of an example Network Configuration according to an alternative embodiment of the invention.

FIG. 5 illustrates an example method according to specific embodiments of the invention.

FIG. 6 illustrates an example method according to specific embodiments of the invention.

FIG. 7 illustrates a further example method according to specific embodiments of the invention.

FIG. 8 illustrates an example method according to specific embodiments of the invention.

FIG. 9 illustrates a further example method according to specific embodiments of the invention.

FIG. 10 is a block diagram showing a representative example logic device in which various components of specific embodiments of the invention may be embodied.

### DESCRIPTION OF SPECIFIC EMBODIMENTS

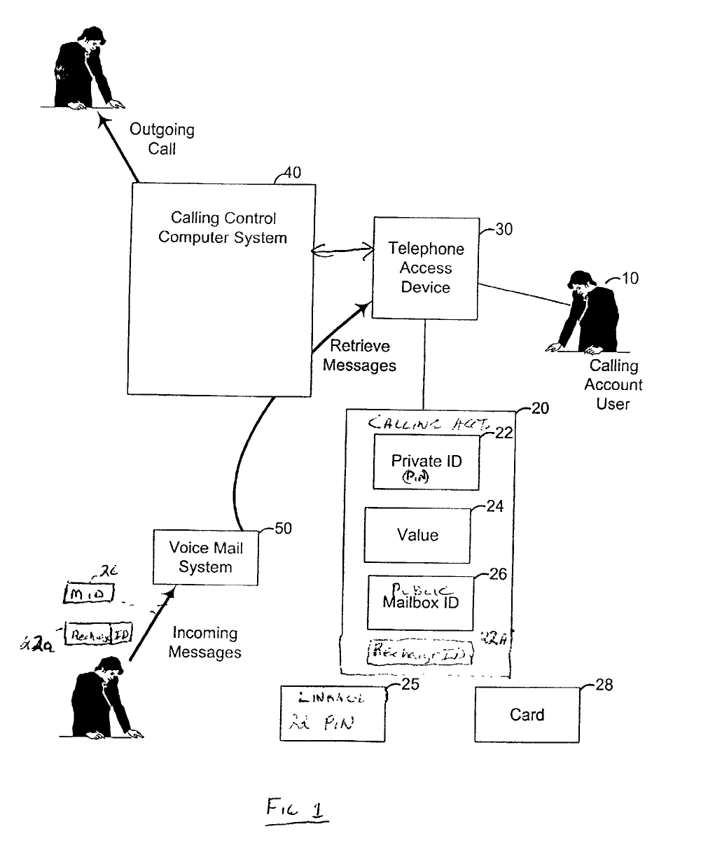

FIG. 1 shows a system according to one embodiment of the invention. As shown, a calling account owner/user 10 obtains a calling account 20. Associated with this calling account is a private identification number (PIN) 22, a value 24, and a public mailbox ID (MBID) 26. According to an embodiment, PIN 22 is required to make phone calls charged to the calling account and to retrieve messages left in the message mailbox associated with the calling account. Value 24 indicates the amount of funds left in the calling account, and according to various embodiments of the invention, this value may be debited by such activities as: placing calls using the calling account, retrieving messages from an associated voice mailbox, retaining messages in storage in an associated voice mailbox, etc. This value also may be debited by a setup fee or periodic service fee for the message mailbox.

To place a call, owner 10 obtains access to a telephone access device 30. According to various embodiments of the invention, access device 30 can be a device on a public service telephone network (PSTN) or a private access device that connects to a system providing the calling account and message services. Access device 30 may be a telephone, a facsimile machine, a computer, or any other type of communication device. Access device 30 may also be a wireless telephone, especially in locations without wired telephone service.

Upon initiating a call on device 30, caller 10 identifies the calling account, which may be accomplished through keypad entry, voice recognized input, a card reader that reads an id from a calling card, or any other input mechanism allowing caller 10 to input PIN 22.

Once PIN 22 has been provided, it is sent to a calling control computer system 40. System 40 determines whether there is sufficient and authorized value 24 associated with the calling account to pay for further activity. At this point, or at any other point, system 40 may inform the caller 10 as to the status of account value 24.

Once a determination has been made that sufficient value 24 exists for further activity, computer system 40 will allow access to caller 10 of the message mailbox in message mail system (VMS) 50 associated with a calling account and allow access to outside phone service.

In one specific embodiment, system 40 will immediately inform caller 10 once the PIN 22 has been entered as to whether any messages including faxes or other types of received message exist in the mailbox associated with calling account 20. At that point, owner 10 can listen to messages or provide other instructions regarding message mailbox or can make outgoing phone calls, including phone calls returning messages.

Calling Cards

According to a further specific embodiment, an account may have associated with it a calling card 28. The calling card may be an inexpensive nonmagnetic printed or written card that contains a private ID and an indication of an initial value. In one embodiment, the card is designed to be discarded after the value associated with the card is exhausted. In this embodiment, the public mailbox ID 26 may be assigned to more than one calling cards 28 having more than one private IDs 22. Thus, an owner 10 can continue accessing calling services by using a number of calling cards 28 that are purchased either at the same time or that may be purchased from time to time.

In an alternative embodiment, a calling card may include a magnetic strip or embedded logic device that includes an identification and may also include a direct indication of the value of the calling card and other information associated with the user such as identification of speed dial numbers, etc.

Disposable Cards

Using disposable cards allows for some increase in security because a particular calling card 28 will be associated with a PID 22 that will only be active until the value on the calling card has been exhausted. A lost or stolen card, therefore, will only result in a fixed amount of lost value and a fixed amount of unintended access to the calling account. Lost cards may be disabled and balances may be refunded to account owners or transferred to new cards with new PIDs in specific embodiments of a service or system according to the present invention.

In a further embodiment, a caller may be required to provide additional identification when purchasing calling cards 28 in order to connect a calling card 28 to a particular mailbox ID 26. This identification procedure may include assigning a second private mailbox id 25 that is only used to establish a linkage between a card 28 (with a PIN 22) and a public mailbox ID 26. A caller may also be required to positively identify themselves with a form of ID or a signature in order to link a new calling card 28 to an existing public mailbox ID 26.

Recharge Feature Using Mailbox ID or Recharge PIN

In a further embodiment, calling account 20 can be established in such a way that it can have value added to it through deposit of additional prepaid funds. In one embodiment, these prepaid funds are typically added by an account owner/user such as 10, using any of the IDs associated with a calling account For example, in the least technologically advanced areas, an owner/user may simply buy an additional paper calling card, with a new PIN 22, and have that card associated with mailbox ID 26, so that the card can be used to access features associated with mailbox 26. The association can be done either at the time of purchase or when user 10 attempts to use the new card to access the mailbox.

System Embodiments

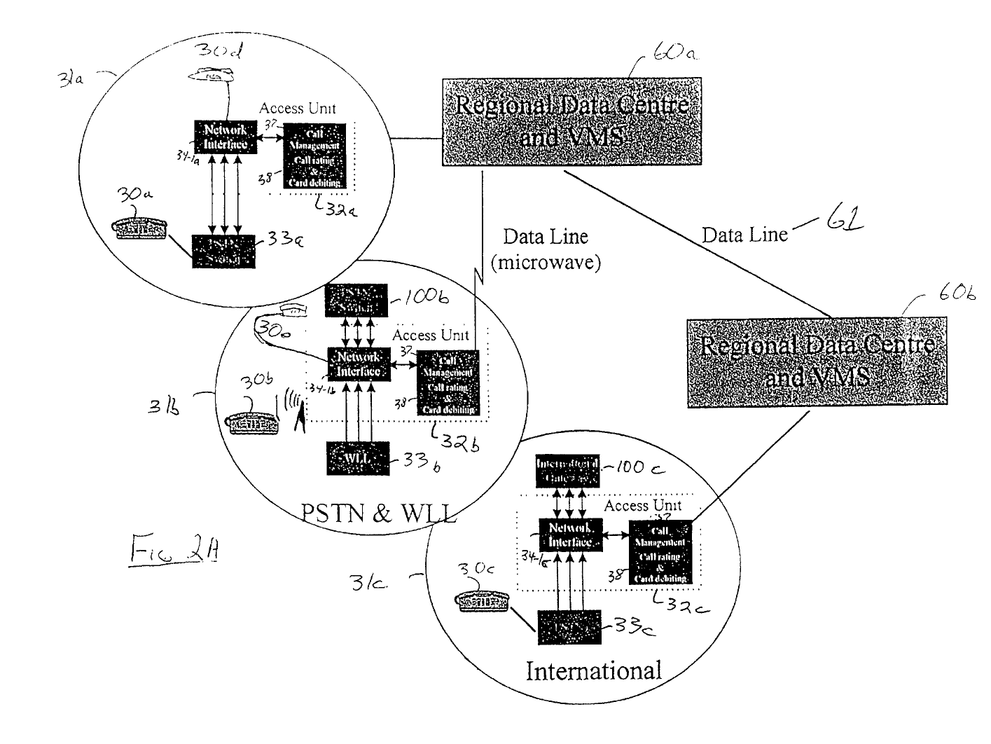

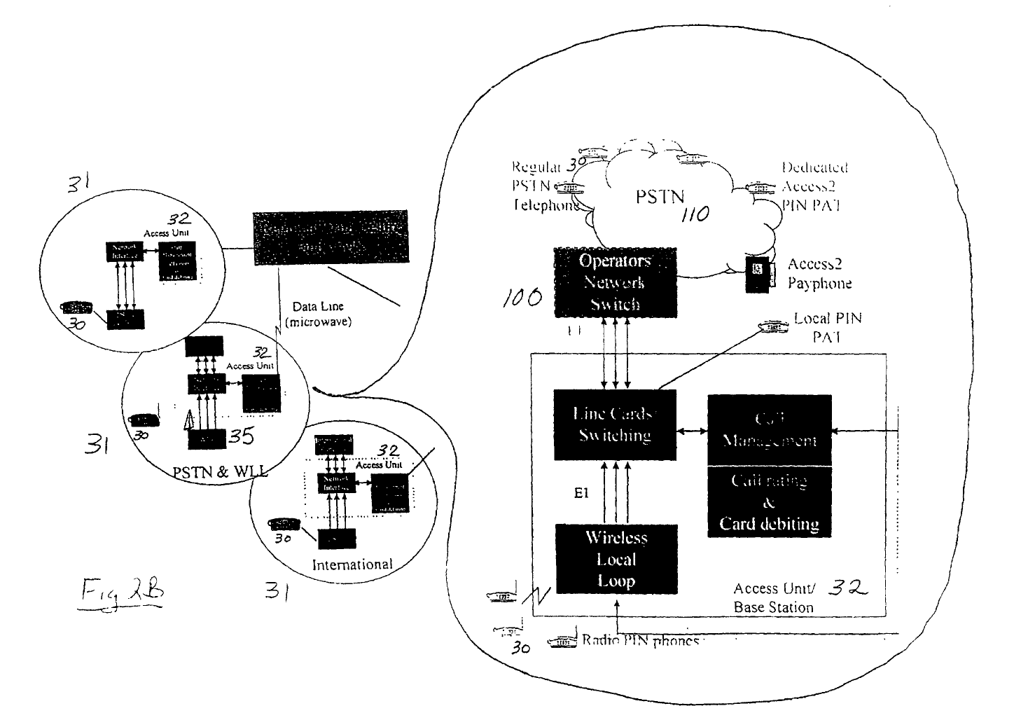

FIG. 2 shows a communication system with components or methods according to a further specific embodiment of the invention. Shown in FIG. 2 are three access installations 31a-c. Each installation includes an access device 30, with a connection 33 to a local access unit 32. In this embodiment, call management, account rating, and account debiting are performed primarily by the local access device. Each installation 31 has some type of data connection to a Regional Data Center 60. The Regional Data Centers handle more centralized functions for calling accounts, including, according to various embodiments, a message mail system. As shown in the figure, centers 60 will typically have a connection for communication with each other such as over data line 61. FIG. 2 illustrates alternatives examples for connecting access device 30 to access unit 33 including public service interface network (PSIN) switches 33a and 33c, direct local connection from devices 30d and 30e, and wireless local loop (WLL) 33b. FIG. 2 further illustrates that access units 32 provide access through a communications line to regional centers 60 and can also provide access to a local connection to a communications network, such as PSTN switch 100b or international gateway 100c.

FIG. 2B is an alternative more detailed block diagram of a telephone and messaging system according to an embodiment of the invention.

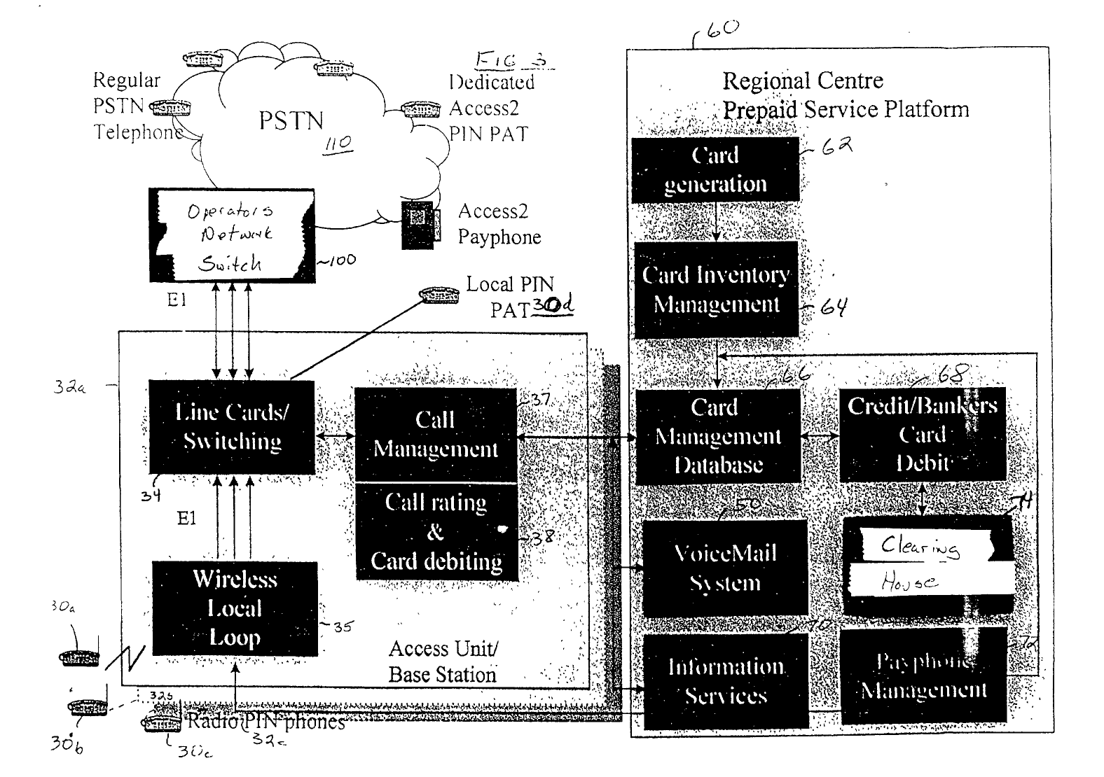

FIG. 3 illustrates an alternative embodiment, providing additional details, of a portion of a communication system with components or methods according to a further specific embodiment of the invention. Shown in FIG. 3 are three access units/base stations 31a-c, each connected to one or more communication devices 30. In this figure, a WLL 35 is assumed to provide the connection with one or more telephone 30, though other embodiments are possible. The access units provide a controlled connection to an operators network switch 100, which then provides connection to a PSTN 110. PSTN 110 can connect a wide variety of communication devices. Access units 32 also have management, rating, and debit components 37 and 38 that are in communication with a regional center 60. Regional center 60 can include a message mail system 50 and can also include card generation 62, card inventory management 64, card management database 66, credit/bankers card debit 68, information services 70, payphone management 72, and clearing house 74.

Other Advantages

It may be seen that the system just described may employ a number of desirable methods according to embodiments of the invention for providing telephone services in less technologically or economically developed areas.

One such service is that in specific embodiments telephone cards as just described may be inexpensive printed or written cards that may be discarded after use. Such cards can allow for very short term commitments of funds to telephone use and can reduce concerns regarding unauthorized use or theft.

As in example, in some instances, a relatively low-value card may be purchased by a person who generally has limited access to cash and who prefers to make smaller cash purchases for telephone service access.

As a further example, a parent, for example, may wish to give a child the ability to access telephone services and messaging services, but may be concerned about providing an identification number that can allow unexpected charges to accrue. In such a case, the parent can provide a prepaid card with an access identification that expires when the fees on the card run out The prepaid card may or may not be linked to a family mailbox, at the parent's discretion. Similarly, a parent could provide several cards, with several identifications and values, to several family members.

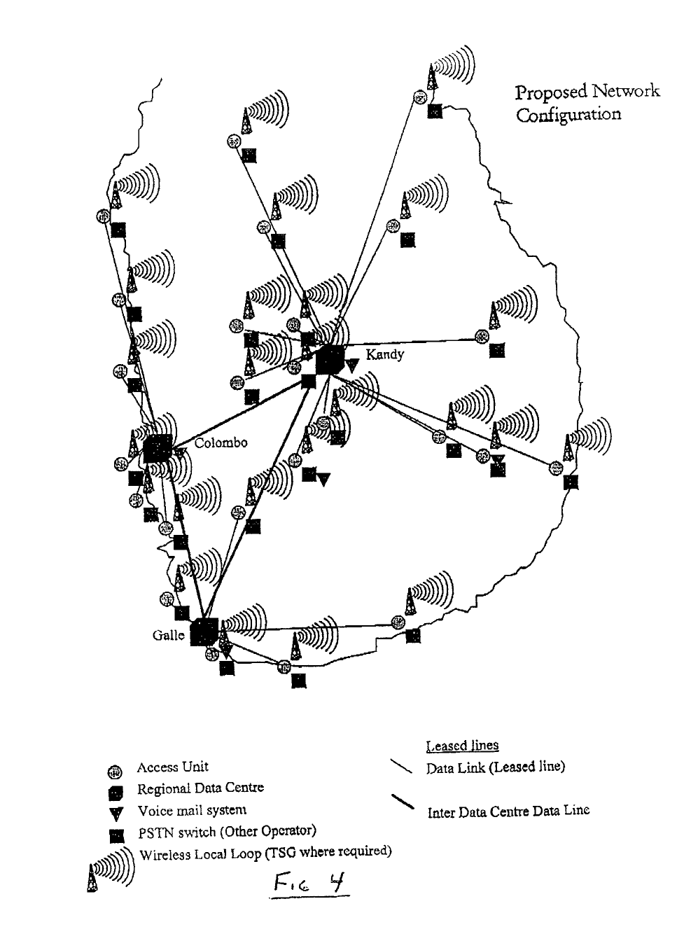

FIG. 4 is an illustration of an example Network Configuration according to an alternative embodiment of the invention.

FIG. 5 illustrates an example method according to specific embodiments of the invention. As can be seen from the figure, this example method allows an account owner to withdraw some funds from a calling account 20 as cash. As discussed elsewhere herein, these funds may have been deposited into the account at a distant location from the location of the owner of account 20.

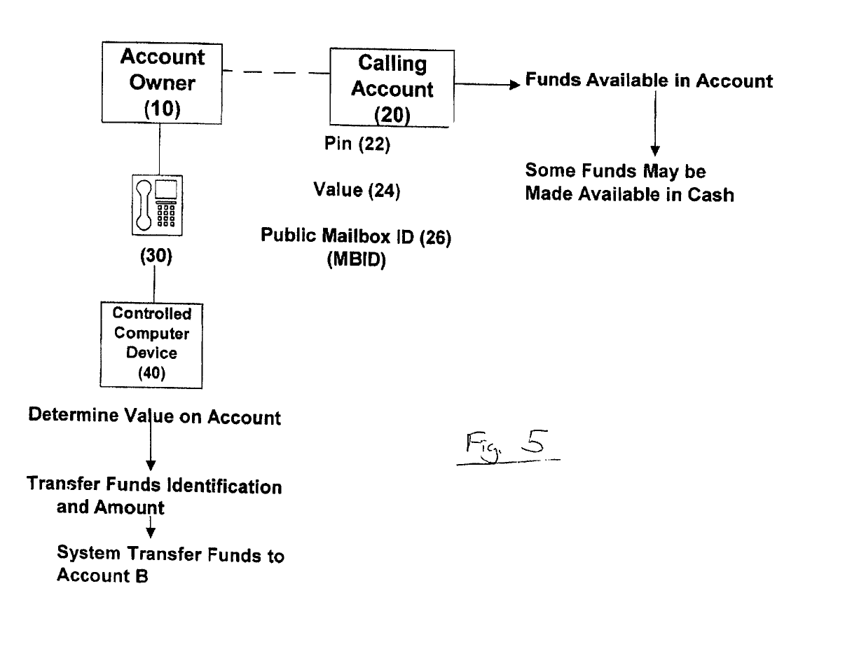

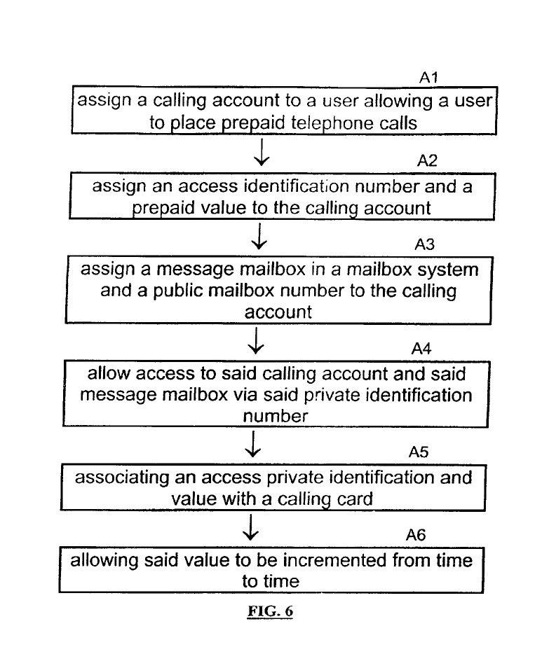

FIG. 6 illustrates an example method according to specific embodiments of the invention. As illustrated, in this general method, a number of telephone services can be made available using a message mailbox calling account according to specific embodiments of the present invention.

FIG. 7 illustrates a further example method according to specific embodiments of the invention. As illustrated, in this method an optional recharge identification number can be assigned to the call account to allow a person, other than a user, to add finds to a call account using a recharge identification number. The user/owner of the account can then access funds from the call account, either for calling services or for other services, include cash, where that option is enabled. According to specific embodiments of this aspect of the invention, the recharge identification number (or PIN) can be equivalent to a public mailbox number, thus allowing anyone to add funds to a calling account.

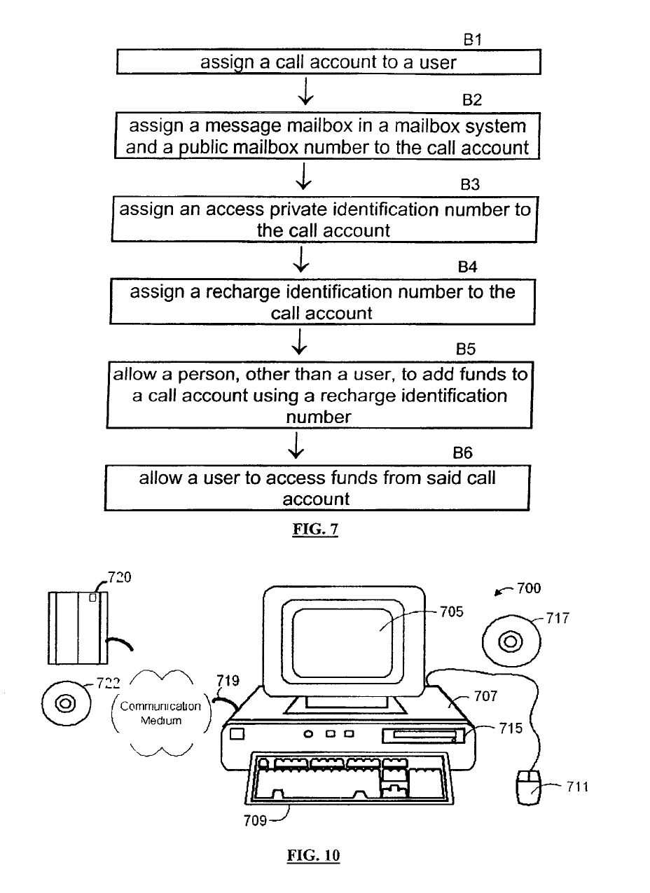

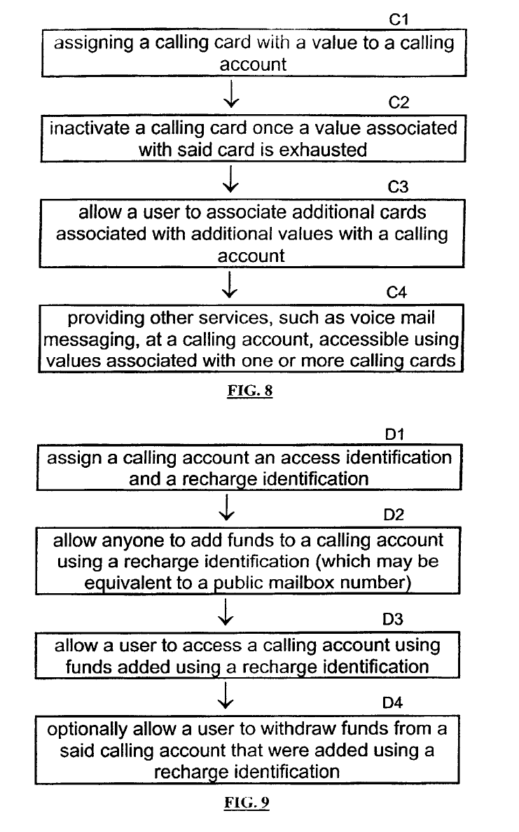

FIG. 8 illustrates an example method according to specific embodiments of the invention. As illustrated, in this general method, a number of telephone services can be made available using a message mailbox calling account according to specific embodiments of the present invention, using a prepaid calling card to provide increased flexibility and optionally increased security in accessing a calling account.

FIG. 9 illustrates a further example method according to specific embodiments of the invention. As illustrated, in this general, a calling account can have assigned to it an access identification and a recharge identification and anyone can add funds to a calling account using a recharge identification (which may be equivalent to a public mailbox number) thus allowing a user to access a calling account using funds added using a recharge identification and optionally allow a user to withdraw funds from a said calling account that were added using a recharge identification.

Embodiments in a Programmed System

Various aspects of the invention can be implemented in hardware and/or software. The invention may be embodied in a fixed media or transmissible program component containing logic instructions and/or data that when loaded into an appropriately configured computing device cause that device to perform according to the invention.

FIG. 10 shows digital device 700 that may be understood as a logical apparatus that can read instructions from media 717 and/or network port 719. Apparatus 700 can thereafter use those instructions to direct a server or communication device or application as is known in the art and that further includes the components of the invention. One type of logical apparatus that may embody the invention is a computer system as illustrated in 700, containing CPU 707, optional input devices 709 and 711, disk drives 715 and optional monitor 705. Fixed media 717 may be used to program such a system and may represent a disk-type optical or magnetic media or a memory. The invention may be embodies in whole or in part as software recorded on this fixed media. Communication port 719 may also be used to program such a system and may represent any type of communication connection. Such a system can server as calling control computer 40.

The invention also may be embodied in whole or in part within the circuitry of an application specific integrated circuit (ASIC) or a programmable logic device (PLD). In such a case, the invention may be embodied in a computer understandable descriptor language which may be used to create an ASIC or PLD that operates as herein described.

Conclusion

The invention has now been explained with regard to specific embodiments. Variations on these embodiments and other embodiments will be apparent to those of skill in the art. The invention therefore should not be limited except as provided in the claims provided herein.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

[image]

[image]

[image]

[image]

[image]

[image]

[image]

[image]

[image]

What is claimed is:

1. A system providing calling account with message mailbox services comprising:
an access private identification number for accessing said calling account;
a value indicating available finds in said calling account;
an electronic message mailbox system for accepting messages into a plurality of mailboxes and presenting messages to mailbox owners;
a public mailbox identification allowing anyone to leave messages in a mailbox, said mailbox accessed by said access private identification number;
a calling control system for receiving said private access identification and when said identification has been verified and said account value has been checked allowing access to a call placement system and to a message system.

2. The system according to claim 1 wherein said access private identification and said value are associated with a calling card.

3. The system according to claim 1 wherein said value may be incremented from time to time.

4. The system according to claim 1 wherein said access private identification is associated with a fixed value and wherein said private identification becomes permanently inactive once said value is exhausted.

5. The system according to claim 1 wherein said access private identification is associated with a fixed value and wherein said private identification become permanently inactive once said value is exhausted and wherein additional private identifications associated with additional values may also be associated with said calling account.

6. The system according to claim 5 further comprising:
a second identification used to associate said additional private identifications associated with said calling account.

7. The system according to claim 4 wherein said access private identification and said value are associated with a calling card.

8. The system according to claim 1 wherein said calling control system comprises:
a plurality of logic devices including a local access device and a central computer.

9. The system according to claim 8 wherein an initial verification of an access private identification number is provided by said local access device.

10. A method for providing calling and message mailbox services comprising:
assigning a calling account to a user, said calling account allowing said user to place prepaid telephone calls;
assigning an access private identification number and a prepaid value to said calling account;
assigning a message mailbox in a mailbox system and a public mailbox number to said calling account; and
allowing access to said calling account and said message mailbox via said private identification number.

11. The method according to claim 10 wherein said access private identification and said value are associated with a calling card.

12. The method according to claim 10 wherein said value may be incremented from time to time.

13. The method according to claim 10 wherein said access private identification and said value are associated with a calling card and wherein said calling card and said private identification become inactive once a value associated with said card is exhausted and further wherein additional cards associated with additional values may also be associated with said calling account.

14. The method according to claim 10 wherein said access private identification and said value are associated with a calling card and wherein said calling card and said private identification become inactive once a value associated with said card is exhausted and further wherein additional cards associated with additional values may also be associated with said calling account and further comprising a second private identification number for associating a card and an access private identification number with a calling account.

15. A method of providing and billing for calling and electronic mailbox access using one or more computers comprising:
assigning a calling account to a user;
assigning an access private identification number and a prepaid value to said calling account and storing that assignment in a control computer system;
assigning a message mailbox in a mailbox system and a public mailbox number to said calling account;
prompting said user for said access private identification number,
using said control computer system to verify said access private identification number and to verify that sufficient finds are available for account access; and
allowing access to said calling account when a verification is positive.

16. The method according to claim 15 wherein said control computer system comprises a plurality of logic devices including a local access device and a central computer and wherein an initial verification of an access private identification number is provided by said local access device.

17. The method according to claim 15 wherein said access private identification and said value are associated with a calling card.

18. The method according to claim 15 wherein said value may be incremented from time to time.

19. The method according to claim 15 wherein said access private identification and said value are associated with a calling card and wherein said calling card and said private identification become inactive once a value associated with said card is exhausted and further wherein additional cards associated with additional values may also be associated with said calling account and further comprising a second private identification number for associating a card and an access private identification number with a calling account.

20. A calling account with two access identifications comprising:
an access private identification number for accessing said calling account;
a value indicating available funds in said calling account; and
a recharge identification number allowing adding finds to said calling account, but not allowing use of said calling account.

21. The account according to claim 20 further comprising:
an electronic message mailbox system for accepting messages into a plurality of mailboxes and presenting messages to mailbox owners;
a public mailbox identification allowing anyone to leave messages in a mailbox, said messages retrieved using said access private identification number; and
a calling control system for receiving said private access identification and when said identification has been verified and said account value has been checked allowing access to a call placement system and to a message system.

22. The account according to claim 20 wherein said access private identification and said value are associated with a calling card.

23. The system according to claim 20 farther comprising:
a calling control computer system for receiving said private access identification and when said identification has been verified and said account value has been checked, allowing access to a call placement system and to a message system.

24. The system according to claim 20 wherein said access private identification is associated with a calling card.

25. The system according to claim 20 wherein said value may be incremented from time to time, either through deposit of finds or through an electronic transfer identified by said recharge identification.

26. The system according to claim 20 wherein said access private identification is associated with a calling card and wherein said calling card and said private identification become permanently inactive once a value associated with said card is exhausted.

27. The system according to claim 20 wherein said access private identification is associated with a calling card and wherein said calling card and said private identification become inactive once a value associated with said card is exhausted and further wherein additional cards associated with additional values may also be associated with said calling account.

28. A method for transferring funds comprising:
assigning a calling account to a user;
assigning an access private identification number to said calling account;
assigning a recharge identification number to said calling account;
allowing a person, other than a user, to add finds to said calling account using said recharge identification number; and
allowing a user to access funds from said calling account using said private identification number.

29. The method according to claim 28 further comprising:
assigning a message mailbox in a mailbox system and a public mailbox number to said calling account.

30. The method according to claim 28 wherein said access private identification and said funds are associated with a calling card.

31. The method according to claim 29 wherein said public mailbox number may be used as said recharge identification number.

32. The method according to claim 28 wherein said access private identification and an initial value are associated with a calling card and wherein said calling card and said private identification become inactive once a value associated with said card is exhausted and further wherein additional cards may also be associated with said calling account.

33. The method according to claim 32 further comprising:
assigning a second private identification number for associating a card and an access private identification number with a calling account.

34. A system for providing a message mailbox with a call origination capability comprising:
a message mailbox system accessible from a plurality of communications devices;
an access identification for accessing a message mailbox in said system;
a menu allowing an owner of said mailbox to select from a number of functions;
a function choice allowing a user to place a call through a public communication network, said call having a call identification indicating said voice mailbox.

35. The system according to claim 34 further comprising:
a value indicating available finds associated with a message in said mailbox.

36. The system according to claim 35 further wherein said available funds associated with a message are restricted to allow playback of said message and a return phone call to an indicated phone number.

37. The system according to claim 34 further comprising:
a public mailbox identification allowing anyone to leave messages in a mailbox, said mailbox accessed by said access private identification number.

38. The system according to claim 34 further comprising:
a calling control computer system associated with said voice mailbox for receiving said private access identification and when said identification has been verified and said account value has been checked allowing access to a call placement system.

39. The system according to claim 34 wherein said access private identification is associated with a calling card.

40. A method for originating calls from a message mailbox comprising:
receiving a connection to a mailbox system;
receiving an access number for a mailbox;
verifying said access number;
providing menu prompts to a user, including an option to originate a call;
completing a call, when selected, through a public network, and including a public mailbox identification as the call origination of said call.

41. The method according to claim 40 further wherein there is no telephone number equivalent to said mailbox number and any returned call placed to said mailbox number is necessarily placed into said mailbox system.

42. The method according to claim 40 further comprising:
assigning an account to a user;
assigning an access private identification number and a prepaid value to said calling account and storing that assignment in a control computer system;
assigning a recharge identification number to said calling account;
prompting said user for said access private identification number;
using said control computer system to verify said access private identification number and to verify that sufficient funds are available for account access; allowing access to said account when a verification is positive; and
when requested by a user connecting to a message in said mailbox;
prompting a user whether the user wishes to place a call to a number associated with a message.

43. The method according to claim 41 wherein further comprising ascertaining that payment is available to listen to or return a particular message in said mailbox.

44. The method according to claim 40 wherein said mailbox is associated with a prepaid calling account.

45. The method according to claim 40 further comprising:
prompting a user for a log-in;
prompting a user for a menu choice, including a “make call” menu choice;
allowing a user to enter a phone number or a speed-dial number; and
wherein said mailbox is associated with a prepaid calling account.

46. The method according to claim 45 further comprising:
providing speed dialing options as the sole options for making a call

47. The method according to claim 45 further comprising: providing speed dialing options that are programmable by another party;

48. The method according to claim 45 further comprising:
providing a user an option to place two or more calls from a message mailbox in order to make a conference call.

49. The method according to claim 45 further comprising:
providing a “meet me” option so that a select number of calls could originate elsewhere to allow for a multi-caller phone conference.

50. The method according to claim 40 wherein said access private identification and said value are associated with a calling card and wherein said calling card and said private identification become inactive once a value associated with said card is exhausted and further wherein additional cards associated with additional values may also be associated with said calling account.

51. The method according to claim 40 wherein said access private identification and said value are associated with a calling card and wherein said calling card and said private identification become inactive once a value associated with said card is exhausted and further wherein additional cards associated with additional values may also be associated with said calling account and further comprising a second private identification number for associating a card and an access private identification number with a calling account.

52. A system for providing a message mailbox comprising:
an electronic message mailbox system able to accept messages into a plurality of mailboxes and present messages to mailbox owners, said mailbox locally accessible from a first calling area;
a public mailbox identification allowing a party to leave messages in a mailbox, said mailbox accessed by said access private identification number;
an access private identification allowing access to said mailbox; and
a message acceptance access point, remote from said mailbox system and locally accessible from a second calling area, allowing a party to leave a message for a mailbox, wherein said message is later transmitted to said mailbox system.

53. The system according to claim 52 wherein said message mailbox is accessed via a public telephone network and further comprising:
a first calling area access phone number for connecting to said electronic message mailbox system; and
a second calling area access phone number for connecting to said message acceptance module.

54. The system according to claim 52 wherein said message mailbox is accessed via a public telephone network and further comprising:
a first calling area access phone number for connecting to said electronic message mailbox system;
a plurality of second calling area access phone numbers for connecting via a local phone call to one or more message acceptance modules; and
wherein said public identification comprises a mailbox number which may be used to identify a mailbox for message receipt via any of said message acceptance modules.

55. The system according to claim 53 wherein said first calling area access phone number and/or said second calling area access phone number are fee-per-access numbers.

56. The system according to claim 53 wherein said first calling area access phone and/or said second calling area access phone number are toll-free numbers.

57. The system according to claim 53 wherein said first calling area is in a different country from said second calling area.

58. A method for allowing a caller to leave a message for a receiving party located in a different calling region comprising:
accepting a phone call at a message acceptance station;
receiving a mailbox identification;
receiving a message;
storing said message for transmission to a voice mailbox system;
transmitting said message to said voice mailbox system;
accepting a connection at said voice mailbox system;
verifying an access identification; and
presenting said message.

59. The method according to claim 58 further comprising:
accepting payment information associated with said message;
transmitting said payment information associated with said message; and
presenting said message in accordance with said payment information.

60. The method according to claim 59 wherein said payment information comprises prepaid funds for accessing said message.

61. The method according to claim 59 wherein said payment information comprises a charge authorization for accessing said message.

62. The method according to claim 59 wherein said payment information includes authorization to pay for a return phone call to a specified number.

63. A method providing economical international voice messaging comprising:
accepting a phone call at a message acceptance station in a first country, said phone call connectable via a local or toll-free connection;
receiving a mailbox identification indicating a message mailbox in a second country;
receiving a message;
storing said message for transmission to a message mailbox in a second country;
accepting a connection in said second country to said voice mailbox system;
verifying an access identification; and
presenting said message.

64. The method according to claim 63 further comprising:
accepting payment information associated with said message in said first country;
storing and transmitting said payment information associated with said message to a message mailbox system; and
presenting said message in accordance with said payment information.

65. The method according to claim 63 wherein said payment information comprises prepaid funds for accessing said message.

66. The method according to claim 63 wherein said payment information comprises a charge authorization for accessing said message.

67. The method according to claim 63 wherein said payment information includes authorization to pay for a return phone call to a specified number.
